(19) United States
(12) Patent Application Publication
(10) Pub. No.: US 2017/0053292 A1
(43) Pub. Date: Feb. 23, 2017

(54) METHOD OF CHECKING THE AUTHENTICITY OF AN OBJECT

(71) Applicant: Eric BAUER, HERGISWIL (CH)

(72) Inventor: Eric BAUER, HERGISWIL (CH)

(21) Appl. No.: 15/119,779

(22) PCT Filed: Mar. 6, 2015
(86) PCT No.: PCT/IB2015/051638

§ 371 Date: Aug. 18, 2016

(30) Foreign Application Priority Data
Mar. 12, 2014 (CH) 00367/14

(51) Int. Cl. G06Q 30/00; G06K 7/10; G06K 7/14

(52) U.S. Cl. CPC G06Q 30/0185; G06K 7/1417; G06K 7/10366

(57) ABSTRACT

A method of authentication of an object between a monitoring station and a verification post in which the object to be monitored bears a first visible information element and a second information element in the form of an electronic tag. During the monitoring, the first and the second information element carried by the object are read with the aid of an appropriate reader and transmitted to a verification post by transmission elements. On receipt of this information, the verification post applies a rule of concordance to the elements transmitted and verifies that the information received does indeed correspond to an original object. If such is the case, the verification post dispatches a positive signal to the monitoring station; in the converse case, a negative signal indicating that the article is not an original article is sent.

This invention relates to a method for checking an object, more particularly a method that makes it possible to verify the authenticity of an object such as a watch, a piece of jewelry, a medication, or any other object of value. This method is particularly suitable, for example, during Customs checks to ensure that the object being checked really comes from a specified manufacturer and that it is not a counterfeit. The method that is the object of the invention implements means for acquiring and transmitting data between a checking station and a verification post in which all of the data circulating in the telecommunication networks are encrypted. Furthermore, all of the sensitive data that make it possible to verify that one is in the presence of an original object are preserved in a single location and are not accessible during the transmission of bidirectional information between the checking point and the verification post.

The problem that this invention proposes to solve consists in not transmitting sensitive information between the checking point and the verification post that will attest to the authenticity of the object checked by a fast and unambiguous verification. It should also be noted that all of the information relative to the object to be checked is preserved only at the place where the verification post is located.

For this purpose, the method according to the invention is distinguished by the characteristics indicated in claim 1.

Other advantages will emerge from the following description and characteristics expressed in the dependent claims.

For the implementation of the method according to this invention, each original object comprises at least two distinct means of identification. A first identification means is visible from the exterior of the object. It may involve, for example, a bar code or a QR code affixed to the object or its packaging. A second identification means in the form of an electronic label or an RFID tag or any other device of this type that can be read remotely by a suitable reader is installed in the object and preferably is not visible from the outside of the object.

By way of example, in the case of checking to be performed to ensure the authenticity of a precision timepiece such as a watch, the watch case is equipped on its outer part with a bar code or a QR code affixed to the rear of the case. An RFID tag, being used as a second identification means, is integrated with its antenna in the watch case.

The RFID tag or electronic label is a simple and compact device that generally comprises a unique serial number that can be read without contact using a reader emitting a radiant field that activates the tag when the latter is within the range of the reader. It will also be noted that these passive tags, in their simplest version, do not offer the possibility of writing data. They consist of a unique serial number that can be read remotely during the activation of the tag by the reader but that cannot be modified.

The visible identification element, for example the QR code appearing on the object, carries a portion of the information necessary to identify the object.

So as to prevent the visible identification element from being reproduced or falsified, it comprises only a portion of the information necessary to identify the object.

In the same way, the single tag does not make it possible to guarantee the authenticity of the object. It is actually a combination of the information carried by the QR code and the information relative to the single serial number of the electronic tag that makes it possible to determine the authenticity of the object to be checked.

The manufacturer selects what information he wants to use from among that appearing to the visible element, the first identification means, and that carried by the tag to verify the authenticity of the object. The manufacturer can use, for example, the unique serial number of the electronic tag in combination with all or part of the information carried by the QR code. Thus, even in the case where the visible element is reproduced just the same on a counterfeit object, the information carried by this element does not make it possible to obtain a positive result because the information contained in the tag will be missing.

The fraudulent installation of a tag in the object no longer makes it possible to identify the object in an unambiguous manner because it will lack the information carried by the first information element.

The manufacturer of the object to be checked decides how he wants to combine the information carried by the visible element and that contained in the tag for establishing an unambiguous correspondence list between the combination of this information and the internal references of the original object. This increases the reliability of the system since only the manufacturer knows how the information carried by the different identification elements is to be combined.

Thus, for each object, the manufacturer establishes a list in a computer file that contains all of the information relative to the object (reference, manufacturing date, place of manufacture, appropriate characteristics of the object, etc.). This computer file also comprises the combination of the information contained in the tag and that carried by the visible information element. The thus constituted computer file references all of the original objects as well as the selected combination of information making it possible to authenticate it. Any combination between the first and the second information elements is conceivable.

During a checking of the object, for example by Customs, the object to be verified is presented to a combined reader that will read both the QR code and the serial number of the electronic tag. Preferably, a suitable reader will be used that comprises an optical reader to read the visible element and a high-frequency reader that makes it possible to activate the electronic tag and to recover its serial number.

The combined reader is coupled to a data transmission device such as a portable computer or a mobile telephone that can transmit the data acquired by the reader to the verification post.

The data acquired by the reader are encrypted by the transmission device before being transmitted to the verification post. For this purpose, any form of known encryption can be used, such as, for example, an RSA-type asymmetrical encryption or a DES-type symmetrical encryption.

Upon receiving the data, the computer equipment of the verification post decrypts the data received, and then applies to them the concordance rule defined by the manufacturer to obtain a number or a string of characters that corresponds to an entry in the database of original articles. The verification post then accesses the database using transmitted information and the number obtained by the concordance rule and verifies whether this information corresponds to a specific object. In the case where the concordance between the elements received and an original article is verified, the verification post then transmits a positive signal to the checking station via the transmission means indicating that it is indeed an original article. If the concordance rule applied to the received information elements does not make it possible to identify an original article in an unambiguous manner, a negative signal is transmitted to the transmission means of the checking station.

Thanks to this method, no sensitive data are transmitted to the communication networks. Even in the case where this transmission is intercepted, the transmitted information cannot be exploited because it consists of only a string of numbers or characters that cannot be used without knowing the concordance rule that makes it possible to authenticate the object. The response sent by the post no longer comprises sensitive elements because only a positive or negative signal is sent to the checking station. Finally, all of the data making it possible to verify—using the concordance rule—that the information elements read and transmitted during the checking readily correspond to an original article are located at a single location, in the databases of the computer systems of the verification post. It thus is not necessary to transmit lists of articles to the checking station as is done traditionally.

1. Method for authentication of an object between a checking station and a verification post comprising the following stages:
Reading a first visible information element on the object to be checked;
Reading a second information element hidden in the object;
Aggregation of two information elements and transmission of this combined information to a verification post;
Receiving information transmitted by the verification post;
Application of a concordance rule to the information received;
Comparison of the information element obtained with an entry in a preregistered list comprising information relative to the object to be checked;
Transmission of a positive signal in the case of concordance between the information elements received and the existence of the reference of the object or transmission of a negative signal in the case of non-concordance.

2. Method according to claim 1, wherein all of the information transmitted between the checking station and the verification post is encrypted.

3. Method according to claim 1, wherein the first information element carried by the object to be verified is visible on the object and consists of a bar code or a QR code.

4. Method according to claim 1, wherein the second information element carried by the object consists of a tag or an electronic label integrated in the object to be checked.

5. Method according to claim 1, wherein the object to be checked is a precision timepiece and the first identification means consists of a bar code or a QR code affixed to the precision timepiece, and wherein the second identification means consists of an electronic tag hidden inside the precision timepiece.

6. Method according to claim 2, wherein the first information element carried by the object to be verified is visible on the object and consists of a bar code or a QR code.

7. Method according to claim 2, wherein the second information element carried by the object consists of a tag or an electronic label integrated in the object to be checked.

8. Method according to claim 2, wherein the object to be checked is a precision timepiece and the first identification means consists of a bar code or a QR code affixed to the precision timepiece, and wherein the second identification means consists of an electronic tag hidden inside the precision timepiece.

9. Method according to claim 3, wherein the second information element carried by the object consists of a tag or an electronic label integrated in the object to be checked.

10. Method according to claim 3, wherein the object to be checked is a precision timepiece and the first identification means consists of a bar code or a QR code affixed to the precision timepiece, and wherein the second identification means consists of an electronic tag hidden inside the precision timepiece.

11. Method according to claim 4, wherein the object to be checked is a precision timepiece and the first identification means consists of a bar code or a QR code affixed to the precision timepiece, and wherein the second identification means consists of an electronic tag hidden inside the precision timepiece.
